(19) United States
(12) Patent Application Publication
(10) Pub. No.: US 2026/0042599 A1
(43) Pub. Date: Feb. 12, 2026

(54) Secure Container System and Method

(71) Applicant: The Government of the United States of America, as represented by the Secretary of Homeland Security, Washington, DC (US)

(72) Inventors: Jeffrey B. Barber, Vineland, NJ (US); James Weatherall, Linwood, NJ (US)

(73) Assignee: The Government of the United States of America, as represented by the Secretary of Homeland Security, Washington, DC (US)

(21) Appl. No.: 19/293,222

(22) Filed: Aug. 7, 2025

Related U.S. Application Data
(60) Provisional application No. 63/680,917, filed on Aug. 8, 2024.

(51) Int. Cl. B65D 90/48; B65D 88/14; H01Q 1/32; H01Q 21/00; H04W 4/029

(52) U.S. Cl. CPC B65D 90/48; B65D 88/14; H01Q 1/32; H01Q 21/00; H04W 4/029; B65D 2590/0083

(57) ABSTRACT

Embodiments are directed toward a system and method relating to checking container status. For example, a system includes at least one antenna and a controller to receive radio frequency (RF) signals. The controller determines a first indication of RF signals received via the at least one antenna at a first time. The controller determines a second indication of RF signals received via the at least one antenna at a second time after the first time. The controller determines a difference between the first indication and the second indication, and compares the difference to a threshold. The controller indicates indicate a status change or no status change of the container responsive to the difference exceeding or falling below the threshold.

### CROSS-REFERENCE TO RELATED APPLICATIONS

This is a nonprovisional application that claims the benefit of priority from U.S. Provisional Application No. 63/680,917 entitled “Secure Container System and Method,” filed on Aug. 8, 2024, the contents of which are incorporated herein by reference in their entirety.

### STATEMENT OF GOVERNMENT INTEREST

The claimed subject matter was made by one or more employees of the United States Department of Homeland Security in the performance of official duties. The Government has certain rights in the invention.

### FIELD

The present subject matter relates generally to the field of shipping, and more specifically to the field of containers, holds, or rooms.

### BACKGROUND

Stolen cargo along supply chains causes reputational damage, financial losses, and increased insurance premiums. Investigating thefts may disrupt container terminal operations, and highlights the need for effective security measures. Shifting cargo can put cargo crafts at risk. The free surface effect is a mechanism which can cause a watercraft to become unstable and capsize. It refers to the tendency of liquids—and of unbound aggregates of small solid objects, like seeds, gravel, or crushed ore, whose behavior approximates that of liquids—to move in response to changes in the attitude of a craft's cargo holds, decks, or liquid tanks in reaction to operator-induced motions (or sea states caused by waves and wind acting upon the craft). It is beneficial for cargo crafts to detect when cargo contents are shifting.

### SUMMARY

In an embodiment, a system that checks container status includes at least one antenna and a controller to receive radio frequency (RF) signals. The controller determines a first indication of RF signals received via the at least one antenna at a first time. The controller determines a second indication of RF signals received via the at least one antenna at a second time after the first time. The controller determines a difference between the first indication and the second indication, and compares the difference to a threshold. The controller indicates indicate a status change or no status change of the container responsive to the difference exceeding or falling below the threshold.

In another embodiment, a method for monitoring a container includes receiving, by a controller coupled to at least one antenna, radio frequency (RF) signals via the at least one antenna. The method also includes determining a first indication of RF signals received via the at least one antenna at a first time, and a second indication of RF signals at a second time after the first time. The method includes determining a difference between the first indication and the second indication, comparing the difference to a threshold, and indicating a status change or no status change of the container responsive to the difference exceeding or falling below the threshold.

Other features and aspects will become apparent from the following detailed description, which taken in conjunction with the accompanying drawings illustrate, by way of example, the features in accordance with embodiments of the claimed subject matter. This summary is not intended to identify key or essential features of the claimed subject matter, nor is it intended to limit the scope of the claimed subject matter, which is defined solely by the claims attached hereto.

### BRIEF DESCRIPTION OF THE DRAWINGS

One or more embodiments of the subject matter are described in detail with reference to the following drawings. These drawings are provided to facilitate understanding of the present subject matter and should not be read as limiting the breadth, scope, or applicability thereof. For purposes of clarity and ease of illustration, these drawings are not necessarily made to scale.

FIG. 1 illustrates a system to check a status of a container according to an embodiment.

FIG. 2 illustrates a system to check a status of a container according to an embodiment.

FIG. 3A and FIG. 3B illustrate a system to check a status of a container according to another embodiment.

FIG. 4A and FIG. 4B illustrate a system to check a status of a container according to another embodiment.

FIG. 5 is a flowchart illustrating a method to check a status of a container according to an embodiment.

These drawings are not intended to be exhaustive or to limit the subject matter to the precise form(s) disclosed. It should be understood that the present subject matter can be practiced with modification and alteration, and that the subject matter is limited only by the claims and the equivalents thereof.

### DETAILED DESCRIPTION

A system to monitor containers can include a stand-alone unit, such as a control module (also referred to herein as a controller), that can be placed on or inside a container with the contents of the container. Embodiments enable monitoring shipping containers for intrusions, and also enable determining whether contents of shipping containers have shifted or settled. Embodiments of the system can be used with containers or rooms, such as large cargo containers, large cargo holds, smaller metal containers, airplane air cargo containers (also referred to as Unit Load Devices (ULDs), air containers, airplane cargo containers, air freight containers, LD1, LD2, LD3, etc.), and the like.

Containers of smaller sizes enable the system to use radio frequency (RF) signals of interest having decreased wavelengths (corresponding to increased frequency), due to radio frequency cutoff. Embodiments can be used to monitor a room such as a large cargo hold, e.g., by using a relatively lower frequency associated with relatively larger wavelengths to cover the relatively larger volume, compared to the wavelengths used with smaller containers. Embodiments also can use additional antennas, and/or additional power, to cover the relatively larger area. Such embodiments can, e.g., monitor multiple containers stored in the hold of a cargo ship, to determine whether the containers moved around within the cargo hold. A container, in turn, can include a system to monitor the contents of that container. With granular materials, such as boulders, grains, sands, soils, particles, and the like, vibration can cause settlement and small particles to rise to the top. Embodiments of the system can monitor for such changes in composition, whether the container is full or partially full, related to settlement or changes in composition within the material itself. Systems and methods described herein enable safe monitoring of container status, providing security measures and notifications of changes in the container status (e.g., due to intrusions). Embodiments also enable safe monitoring of shifting cargo, to enhance the safety of watercraft or aircraft that might become unstable due to cargo shifts, by providing indications of shifts in cargo inside the containers.

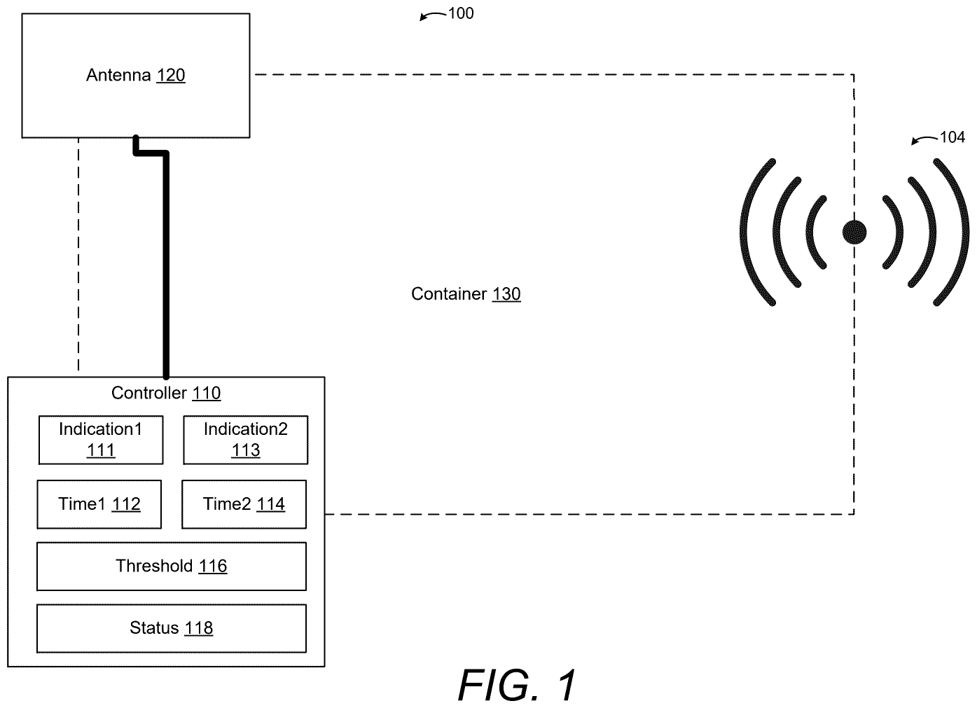

FIG. 1 illustrates a system 100 to check a status of a container 130 according to an embodiment. The system 100 includes antenna 120 and controller 110. The controller 110 is associated with indication1 111, time1 112, indication2 113, time2 114, threshold 116, and status 118, based on radio frequency (RF) signals 104. The controller 110 receives RF signals 104 sensed from at least one antenna 120.

A shipping container, such as an embodiment of container 130, can be formed as a metal box that acts as a Faraday cage with respect to electromagnetic (EM) signals. When the container 130 is closed and secure, EM signals (such as RF signals 104) from outside the container 130 are blocked. When the container is opened or penetrated, EM signals of certain frequencies, such as RF signals 104, can enter the box. The certain frequencies (RF signals 104) that can enter the box are dictated by the size or dimensions of the opening or penetration in the container 130. In an embodiment, the container walls or penetrations in the walls are sealed in terms of electrical shielding, similar to a shielded room. For example, doors include knife-edges along the door frames that mate with the doors, to have conductivity at all surfaces and eliminate gaps/holes. In another embodiment, a standard off-the-shelf container 130 can be used, such that the system uses wavelengths of appreciable sizes that can be detected when the doors are open or the container 130 is otherwise compromised, but whose wavelengths do not appreciably leak into the container 130 (even if unshielded) when the container 130 is closed (e.g., whose wavelengths are longer than any gaps in the wall panels or doors of a standard shipping container). By sensing or monitoring inside the container 130 for the introduction of external electromagnetic signals, such as those from local AM/FM radio stations, satellite GPS, and cell phones, embodiments of system 100 can detect penetrations or openings into the shipping container 130.

Embodiments can passively monitor emissions from radio stations, such as commercial radio stations serving metropolitan areas. Systems can monitor ambient or available RF signals to detect changes in RF characteristics that indicate penetrations, such as holes drilled into the side of the container 130, regardless of whether the penetrations alter the structure of the container. Bethe's “Theory of Diffraction by Small Holes,” Phys. Rev. 66, 163 provides background on the propagation of electromagnetic energy though a circular hole, such as might be caused in penetrating the container. Briefly, the relative power of the signal is proportional to (d/lambda)\hat{ }4, where d is the diameter of the hole and lambda is the wavelength. This indicates that the penetration of radio emission from breaches in the container 130 is a function of frequency, and smaller wavelengths (higher frequencies) are more advantageous to the method of detecting leakage of radiation into the container. In particular, a 10 cm (4 in) circular hole mainly admits radio frequencies above 3 GHz, because the wavelength of an RF signal at 3 GHz is 10 cm. An opening as large as 50 cm will admit 0.1% of the external power incident at the hole in the FM band (88-108 MHz). GPS satellite and cell phone broadcasts are at higher frequency, 1.575 GHz and 1.800-1.950 GHz respectively, and the system 100 can sense such frequencies to detect smaller penetrations. ITU-R P.372 provides information on the ambient background levels of radio-frequency noise from lightning, cosmic emissions, and thermal radiation in the lower atmosphere. At GHz frequencies, the wide-bandwidth noise factor is estimated to be on the order of −50 decibels relative to one milliwatt (dBm), and should be detectable with sensitive receivers that embodiments of the system 100 can use for passive detection. Wide-band ambient noise is estimated to be at −50 dBm, and is measurable with sensitive (expensive) receivers. However, the detection is dependent on how much of the −50 dBm signal penetrates the container 130 and is specific to the detection scenario. Because the container 130 is effectively a Faraday cage, the sealed container 130 can be very quiet with respect to radio frequency. For comparison, commercial shield rooms provide −100 dB in shielding, so small changes in the radio environment will be apparent. Embodiments similarly can use shielding 216 on the container 130 to provide a suitable environment in the container 130.

An embodiment of the system 100 can use known, available signal broadcasts, such as signals that are broadcast over a wide area, such as an entire country or larger areas. The system 100 can monitor RF signals 104 from the known signal when the container 130 is open or otherwise unsecured, to establish a reading corresponding to the container 130 being unsecured. When the container 130 is closed or otherwise secured, the system 100 can establish a baseline reading or lack thereof regarding the known signal. The system 100 can compare sensed signals to the unsecured reading, the baseline reading, or other measurements (e.g., differential measurements of the signal as sensed inside and outside the container 130). In an embodiment, the system 100 senses the time signal from radio station call sign WWVB, broadcast by the WWVB radio station near Fort Collins, Colorado and operated by the National Institute of Standards and Technology (NIST) to cover North America. Embodiments can make use of similar signals throughout the world to provide RF signaling for passive variations of the system 100 that check for characteristics of the signal to determine changes in the container 130 relative to initial conditions or baseline conditions.

In an embodiment, at a first time (time1 112), the controller 110 determines a first indication (indication1 111) of RF signals 104 sensed by the antenna 120. At a second time (time2 114) after the first time, the controller 110 determines a second indication of RF signals 104 sensed by the antenna 120. The controller 110 determines a difference between indication1 111 and indication2 113, and compares the difference to threshold 116. The controller 110 can use a value for threshold 116 corresponding to some value above typical environmental noise or variations. For example, the controller 110 can use a threshold 116 of 20 decibels (dB), which represents a change in signal of 100-fold from background. The controller 110 indicates a status change of the container 130 responsive to the difference exceeding the threshold 116. For example, the controller 110 can store a status indication in memory storage 215, transmit the status indication to a remote server via communication module 214, display the status indication via a display, or otherwise indicate the status indication of the container 130. The controller 110 also can indicate no status change of the container 130 responsive to the difference falling below the threshold 116, e.g., to confirm that the container 130 was not breached during its travels. The controller 110 can monitor RF signals over time and store one or more indications of RF signals and status changes in the memory storage 215.

Embodiments can exploit RF signals available in the open environment, such as frequency modulation (FM) radio, cell phone, cell tower, Wi-Fi emissions, or the like. The system 100 includes an embodiment that is installable in standard containers 130, including shipping containers, and can attach via adhesives, fasteners, or the like to interior surfaces of the container 130. In an embodiment, the controller 110 and antenna 120 are integrated with the container 130 as a fixture. In an embodiment, the controller 110 is integrated with the container 130 to provide a “smart” container 130 that includes the controller 110 and antenna(s) 120. In an embodiment, the system electronics (controller 110) can be mounted on the outside of the container 130 and have a bulkhead connector to the inside of the container 130 to couple the external system electronics to an internal sensing element(s), such as RF antennas, operating or sensing at different frequencies. In another embodiment, the system electronics (controller 110) can be on the interior of the container 130 and have a bulkhead connector to couple the system electronics inside to a communications antenna 120 on the outside of the container 130, to relay signals back to an external or separate monitoring station via cellular or satellite (e.g., using a communications module of the controller 110). Embodiments can be mounted within frame rails of the cargo/shipping container 130, or between corrugations in a wall of the cargo container 130. Embodiments can use shielding to protect electronics/cabling and prevent RF energy leakage into the container 130 from penetrations in the container wall, such as the penetrations that are used to route/run cabling or other communications between system components in and out of the container 130.

An embodiment can include a stub antenna 120 (e.g., a “probe”) that extends into the container 130, allowing for RF signals to be sensed by the stub antenna 120 from inside the container 130, e.g., by using the stub antenna 120 to perform a transmission and/or reflection measurement. The stub antenna 120 could be replaced with other antenna designs, such as a flare probe antenna, a flat antenna, and so on. An embodiment of the system 100 can be mounted to the container 130, using a coaxial signal line that is coupled into the container 130 using a coaxial to waveguide adapter. In an embodiment, the signal line interfaces with the container 130 (which serves as a waveguide) in a right-angle transition, also known as an E-plane transition, or orthogonal transition. Other embodiments can use in-line transitions, which can use a short circuit which sets up a time-varying magnetic wave which couples down the container 130 serving as a guide. The shorting elbow can be a 90-degree piece of rectangular cross-section.

Embodiments can include a “back-short” positioned some distance “D” away from the probe (stub antenna). The back-short reflects electromagnetic (EM) energy, that was propagating from the antenna 120 the wrong way (e.g., away from the interior of the container 130). The back-short reflects that EM energy back toward the probe, where it combines in-phase with the incident wave moving toward the interior of the container 130. Thus, the probe sets up a time-varying electric field, which is constrained to propagate down the guide. The distance D is usually somewhat smaller than a quarter of a guide wavelength at center frequency.

Embodiments can use tuning to adjust a position of the signal, accommodate impedance differences, or the like to increase sensitivity of the circuit. The tuning can be in the form of screws or other mechanisms to adjust a position of the probe, or the distance D to the back short. A height of the probe can be chosen in view of a wavelength of the signal. The lower Transverse Electric waveguide mode 01 (TE01) cutoff of a container 130 serving as a guide occurs when the broad dimension is a half-wavelength in free space. At the center of the band, the broad dimension is ¾ wavelength, and the narrow dimension is (typically) ⅜ wavelength. The probe, e.g., stub antenna, is typically ½ the narrow dimension in height, or 3/16 wavelength at center frequency. However, this is also a parameter than can be varied to optimize a design, along with the diameter of the probe and whether it retains a dielectric jacket or is bare.

An embodiment is a smart container 130 that includes electronics and sensors built into the container 130, so that the container 130 itself serves as the system 100. An embodiment can include an optional accessory, such as an emitter, that remains outside the container 130 and emits RF signals 104 that cannot penetrate through walls of the container 130 for detection by the system 100 inside the container 130, unless the container 130 has been compromised to allow the RF signals 104 inside the container 130 for detection by the system 100 inside the container 130. A system 100 can include an electronics module (controller 110), and an antenna module (antenna 120). The electronics module can include a controller 110, a power source, and the like. The antenna module 120 can be relatively larger, depending on the wavelengths involved. The antenna module 120 can include a thin flat antenna 120 that enables the antenna module 120 to be spread across a surface area of the container interior.

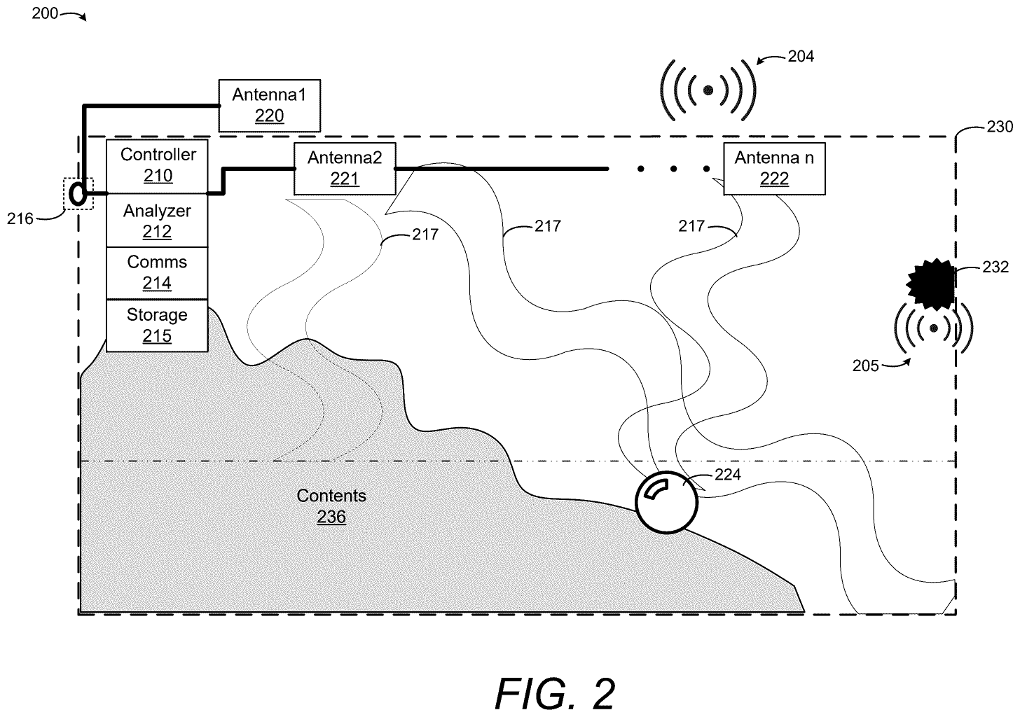

FIG. 2 illustrates a system 200 to check a status of a container 230 according to an embodiment. The container 230 includes hole 232, and contents 236 that have shifted from an initially leveled state. The system 200 includes antenna1 220, antenna2 221, . . . antenna n 222 coupled to controller 210. The system 200 also includes controller 210, analyzer 212, communication module 214, and storage 215. In an embodiment, the controller 210 is coupled to analyzer 212, communication module 214, and memory storage 215. In another embodiment, the controller 210 includes analyzer 212, communication module 214, and storage 215 as part of the controller 210. The controller 210 also is associated with indication1, time1, indication2, time2, threshold, status, and other features as exemplified in FIG. 1. The controller 110 of FIG. 1 also can be associated with the features illustrated in and described with respect to FIG. 2. The controller 210 uses the antennas 220, 221, 222 to detect external RF signals 204 and internal RF signals 205. The controller 210 also can generate (e.g., via analyzer 212) generated RF signals 217, and detect the generated RF signals 217 reflected from inside the container 230. The system 200 includes shielding 216 to shield the orifice for coupling antenna 1 220 to the controller 210, and to shield other parts of the container (e.g., seams, doors, or other openings). The system 200 also includes RF-reflecting target 224.

Embodiments can be active or passive. Passive embodiments enable reduced power requirements, due to making use of available EM or RF signals already present from the environment. An active embodiment can generate and inject generated RF signals 217 into the container 230 using a first antenna (antenna2 221), and monitor the reflected signals using a second antenna (antenna n 222). For example, the container 230 can act as a volume in which the injected generated RF signal 217 reflects and creates nodes. Although the term “nodes” can mean null points in fields, the term “nodes” is used herein more generally to refer to localized field patterns in the volume, including reflection nodes or other such detectable signal characteristics that are affected by changes to the container status. Upon breaching of the container 230, the active embodiment can sense the generated RF signal 217 on the outside of the container 230 by a second antenna (antenna1 220), and/or an antenna inside or outside the container 230 can detect that the reflected signal inside the container 230 could drop or affect the nodes created in the volume. The broadcasted signal (generated RF signal 217) used by active embodiments to detect breaches could be coded with a unique identifier that could be used to alert that container's electronics, or other containers nearby, that a specific container 230 has been breached (by virtue of detecting the unique identifier for that particular container 230).

An embodiment of the system 200 can include the electronics module (e.g., controller 210, analyzer 212) to generate a signal (generated RF signal 217), which the system 200 transmits through a coaxial cable(s) to the antenna(s) 220, 221, or 222. The antenna(s) 220, 221, or 222 emit generated RF signals 217 into the containers 230, which propagate inside and are reflected off the walls and sensed with the same (or different) antenna(s) 220, 221, or 222. In an embodiment, the system includes a controller module 210, cabling, and two flat antennas 220, 221, or 222. The controller module 210 is mounted inside the container 230, and communicates with the two flat antennas 220, 221, or 222 via cabling to determine changes sensed by the antenna 220, 221, or 222 (individually per antenna, and/or differentially by a comparison of the antenna signals). One flat antenna 220, 221, or 222 is mounted on an inside surface of the container 230 (e.g., an underside of the container ceiling), and another flat antenna 220, 221, or 222 is mounted on an outside surface of the container 230 (e.g., an upper surface of the container roof). A cable to the exterior antenna 220, 221, or 222 passes via a through-hole from the outer antenna into the container 230 to the controller module 210. The through-hole can include shielding 216.

During operation of such an embodiment, the signals inside and outside the container 230 reach a steady state when the container 230 is secured, e.g., prior to shipping. Upon changes to the state of the container 230 (doors open, penetration compromising a wall, contents 236 shifted, etc.), the relative strengths of signals reflected back to the electronics also experience changes, which the system 200 detects. In an embodiment, the system 200 applies a statistical evaluation to the detected signals, and determines whether the statistical evaluation indicates changes that satisfy at least a threshold amount of change. Such analysis enables the system 200 to distinguish natural signal fluctuations (e.g., caused by changes in the environment due to travel) from meaningful changes in signal due to shifting container contents 236 or opening or penetration of the container 230. In an embodiment, the threshold is a difference threshold of 20 dB, which represents a change in signal of 100-fold from background. In an embodiment, the system 200 performs an initial threshold test, to sample the signals and establish a baseline start condition, e.g., after securing a container 230 or before travel. The system 200 can perform a differential sampling, using an antenna 220 outside the container 230 and an antenna 221 or 222 inside the container 230, to establish the baseline start condition. For example, the system 200 measures a signal 204 having a first strength outside the container 230, and measures the signal 205 having a second strength inside the container 230, and determines a differential between the first and second strengths. The system 200 can monitor continuously or periodically for changes in the differential that correspond to changes in the container 230, such as opening or breaching of the container 230. In an embodiment, the system 200 includes a network analyzer 212 having a capability to transmit and receive on the same line/cable, to monitor for differences in relative strength of signals 204, 205, 217 reflected back.

The controller 210 can include, or the system 200 can incorporate (coupled to the controller 210), an analyzer 212 to generate or receive/analyze RF signals 204, 205, 217 via antennas 220, 221, 222. The analyzer 212 can be a signal analyzer, spectrum analyzer, network analyzer, or the like, including a combination of different analyzers. The analyzer 212 can perform analysis of the RF signals 204, 205, 217, including determining signal strength, frequencies, losses, power levels, harmonics, noise, phase, and so on. The system 200 can use a spectrum analyzer to measure signal strengths. The system 200 can use a network analyzer to determine phase information or time-domain analysis of signals.

Antenna2 221 is disposed inside the container 230, and antenna1 220 is disposed outside the container 230. The controller 210 can perform differential measurements between RF signals 204, 205, 217 received by antenna1 220 and antenna2 221 when determining indications of RF signals 204, 205, 217. The system 200 can include an array of antennas 1, 2, . . . n. The controller 210 can identify multiple reflections via the array of antennas 220, 221, 222 to triangulate a location of the RF-reflecting target 224 based on the multiple reflections. The controller 210 can use the array of antennas 220, 221, 222 to detect reflected generated RF signals 217 to characterize RF reflection nodes or other characteristics of the generated RF signals 217 that change due to breaches in the container 230 or shifting of the container contents 236.

The nature of the material (contents 236) can affect how the system 200 works, e.g., a level of absorptiveness of the contents 236 that can affect how much RF energy the contents 236 absorb or reflect back to the antenna(s) 220, 221, 222. Embodiments can take into account the absorptiveness of the contents 236 when operating the system 200, to ensure that the signals propagate sufficiently throughout the container 230 to monitor the contents 236. In an embodiment, the system 200 uses different frequencies to affect absorption, e.g., using lower frequencies to further penetrate the contents 236, to an extent that the system 200 adjusts for depending on the type of materials of the contents 236. If the container 230 is relatively full, the system 200 can function to perform a probe measurement of the contents 236, to measure the volume around the antenna 220, 221, 222 (depending on the penetration of the signals into the contents 236). By using relatively lower frequencies, embodiments can probe a larger volume of the contents 236. If the contents 236 get wet (e.g., a type of change in composition), the water generally can cause more absorption or reflection of the signals. Embodiments can detect such absorption or reflection changes. Embodiments can use an array of antennas 220, 221, 222 to cover relatively larger areas, and also to bounce signals off an upper inner surface of the container 230 to cover a wider area, enabling the system 200 to detect changes in heights of the contents 236 throughout the container 230.

The analyzer 212 is coupled to the controller 210, and can transmit or receive RF signals 204, 205, 217. In an embodiment, the controller 210 includes capabilities of the analyzer 212 to enable the controller 210 to transmit or receive RF signals without need of a separate dedicated analyzer 212. The controller 210 can generate RF signals 217, e.g., using analyzer 212. The controller 210 can inject, via antenna2 221 inside container 230, generated RF signals 217 into the container 230. The controller 210 can sense, using the antenna n 222, the generated RF signals 217 injected by antenna2 221. The controller 210 can use antennas 220, 221, 222 to generate or sense RF signals 204, 205, 217.

In embodiments whose containers are metal enclosures (e.g., shipping containers), the containers 230 also serve as waveguides/resonant cavities for radio frequency (RF) EM fields. Embodiments can measure and monitor the RF characteristics within the shipping container 230, e.g., using a transceiver unit, even after the container 230 is loaded and secured. The RF characteristics inside the container 230 should not change, unless the container 230 is opened in some fashion to allow RF signals 204, 205, 217 to enter or escape the container 230, or unless the contents 236 of the container 230 have shifted. Some materials, such as granular materials like ores, can liquify due to the motion and vibration of shipping. This can lead to shifting of the cargo contents 236 and subsequent sinking of cargo ships or crashing of aircraft. Embodiments can monitor RF characteristics inside the container 230, to detect changes corresponding to shifting of any contents 236 or movement of personnel inside. For example, an embodiment of the system 200 measures the container 230 after the container 230 is filled for transport. The system 200 then monitors the container signals over time, to look for differences in the detected or reflected signals. The system 200 provides an alert indication, to indicate changes that satisfy a predefined threshold value, indicating that an appreciable change in status of the container 230 has occurred.

Using Rectangular Waveguide TEm,n Calculator (https://sibersci.com/rectangular-waveguide-temn-calculator/) and the dimensions of a 40 ft. high cube shipping container 230 (Internal Dimensions (in meters): 12.025 m long×2.352 m wide×2.585 m high per https://www.icontainers.com/help/40-foot-high-cube-container/) leads to a TE1,0 mode of approximately 58 MHz. Embodiments can use this frequency (as well as higher order modes) to monitor the status of the closed container 230 of such dimensions, to look for changes in the frequency and other RF characteristics compared to when the container 230 was initially stuffed and secured. For example, a battery-operated internal radio transceiver embodiment generates and detects the resonant-frequency signal (generated RF signals 217). In an embodiment, the system 200 generates a resonant-frequency signal 217 of an appropriate frequency (such as the 58 MHz frequency calculated for the shipping container as set forth above), corresponding to the size of the container 230 serving as a rectangular waveguide. An embodiment of the system 200 can receive user input regarding the desired resonant frequency. An embodiment can receive user input regarding dimensions of the container 230, whereby controller 210 of the system 200 applies a version of the rectangular waveguide calculator to determine an appropriate resonant frequency that the system 200 uses for the container 230.

An embodiment of the system 200 can use the rectangular waveguide TE mode for monitoring the container 230 for changes, using active emissions from an internal antenna 221, 222. The controller 210 can use this approach for monitoring for penetrations into the container 230. However, when the container 230 is opened, the reflected signal internal to the container 230 would decrease as RF emissions would be allowed to escape. The antenna 220, 221, or 222 can be positioned at the door end of the container 230, allowing the use of nearly any frequency, active or passive, for monitoring for door opening/removal, because the receiving antennas 220, 221, or 222 would be at the opening of the container 230.

The controller 210 can generate RF signals 217 at a resonant frequency corresponding to dimensions of the container 230. For example, the controller 210 can be preconfigured to generate resonant frequencies suitable for dimensions of specific containers (e.g., a shipping container used for cargo on ships). An embodiment of the controller 210 is configurable to receive user input as to the interior dimensions of the container 230, perform a waveguide calculation, and determine resonant frequencies that the controller 210 uses to generate the generated RF signals 217 specifically tailored to those container dimensions.

In an embodiment, the analyzer 212 includes a wideband RF energy transceiver and a frequency analyzer to generate and analyze the RF signals 204, 205, 217. The controller 210 can use the analyzer 212 to transmit generated RF signals 217 into the container 230 via at least one antenna (antenna2 221 . . . antenna n 222), to cause the generated RF signals 217 to reflect off walls of the container 230 and off contents 236 of the container 230. The controller 210 can generate specific generated RF signals 217 based on a geometry of the container 230 and contents 236, to cause the generated RF signal 217 to have RF reflection nodes. The controller 210 can monitor a status of the container 230 and its contents 236 by performing these generate/sense operations over time, to determine indications of RF signals 204, 205, 217 in the container 230 over time. The controller 210 analyzes the difference between the indications over time to, e.g., determine whether RF reflection nodes in the container 230 have changed. The controller 210 can indicate a status change of the container 230 responsive to the RF reflection nodes having meaningfully changed over time. For example, detecting a change in RF signals or RF reflection nodes substantial enough to exceed the threshold corresponding to a breach of the container 230 or shifting of contents 236 of the container 230. The controller 210 can generate (e.g., using the analyzer 212) a time-varying RF signal when transmitting and analyzing the RF signals or RF reflection nodes. For example, the controller 210 can generate signals of a first frequency or wavelength, and ramp up or ramp down the frequency or wavelength over time in order to sweep the container 230 with RF signals of varying characteristics capable of detecting various changes of status in the container 230 or contents 236. For example, the varying wavelengths enable detection of changes corresponding to varying sizes of container breaches.

The communications module 214 is coupled to the controller 210 to communicate with a remote server to exchange instructions and status information regarding the system 200 and the container 230. An embodiment of the system 200 can include the communications module 214, such as a cellular radio and antenna, as part of the controller 210. A user can set up and arm or initialize the system 200 for the container 230, similar to arming a home security system for a home. This initialization establishes a baseline status of the secured container 230 and determines a differential measurement of RF energy 204, 205, 217 inside and outside the secured container 230. An embodiment of the system 200 can communicate its status to the remote server regarding whether the secured container 230 has undergone a status change, such as being compromised. Another embodiment can operate independently of a remote server, without needing to connect back to the server, and can log changes in status stored locally in a memory (storage 215) of the system 200. Upon receiving the container 230, a user can retrieve or review the system log, to see if the container 230 has been compromised at any time since being secured and initialized.

The size of the opening or penetration (hole 232) in the container 230 allows correspondingly sized wavelengths of RF energy 205 to enter the container 230. An embodiment infers a size of the penetration, based on the type of detected wavelengths, by using a wideband RF energy receiver and frequency analyzer 212 to receive signals and determine changes in trends in the received frequency strengths. Embodiments can operate using EM energy including visible light, nonvisible light, or other wavelengths of the electromagnetic energy spectrum. Using RF detection provides advantages over using visible light detection, in that many visibly opaque contents 236 (wood, cardboard, fruit, etc.) are still transparent to RF. In the event of intrusion into the container 230 from the side, other items in the container 230 could be reasonably expected to block stray light to a visible light sensor. However, RF energy would be significantly less impacted by goods, and using RF energy detection enables embodiments of the system 200 to operate regardless of whether visual blockage occurs.

Wavelengths of RF signals 204, 205, 217 range from several millimeters for cellular comms to ˜0.5 kilometer for AM radio signals. Penetrations (hole 232) into the container 230 will pass those signals whose wavelengths are on the order of, or smaller than, the penetration size. Embodiments estimate the size of the penetration by examining the spectrum and determining for the largest wavelength signal.

The hole 232 is a breach in container 230. The controller 210 can determine that RF signals 205 detected inside container 230 have changed over time, due to the introduction of the breach since an initial baseline measurement for RF signals 204, 205, 217 outside and inside the container 230. For example, the controller 210 detects, via antenna2 221, wavelengths entering the container 230 through the hole 232 that were of a wavelength that initially could not pass into the container 230. The controller 210 can identify a hole size corresponding to such newly-detected wavelengths. The controller 210 can identify different events that correspond to different sizes of wavelengths, e.g., whether a relatively small hole 232, or a larger opening corresponding to cargo doors of the container 230 being opened. The controller 210 also can detect changes to the contents 236 of the container 230, based on detecting changes to the wavelengths 205, 217 inside the container 230.

The RF-reflecting target 224 is placed on contents 236 of the container 230, to determine or monitor for shifting or changes in fill level or contents 236. In an embodiment, the system 200 includes a sphere coated with metal as the RF-reflecting target 224. The sphere is placed within or on top of the fill material contents 236 inside the container 230. The system 200 detects and analyzes reflected signals 217 that are reflected off the sphere, to track a position of the sphere. The system 200 can triangulate a location of the sphere, by using multiple antennas 220, 221, 222 distributed around the container 230 and comparing the signals received from the multiple antennas 220, 221, 222. Embodiments of the system 200 also can determine or monitor for fill level by using, in place of or in conjunction with the antennas, electromagnetic transducers, ultrasonic transducers, or the like that reflect signals off the top of the contents 236, enabling the system to monitor changes in the distance from the top of the contents 236 to an inside of a top of the container 230. Initially, the contents 236 were at a level inside the container 230 corresponding to the dashed-dotted line. The RF-reflecting target 224 sat atop the contents 236 at this initial level. During travel of the container 230, the contents 236 shifted, causing the RF-reflecting target 224 to fall downward away from the antennas 220, 221, 222. The controller 210 senses reflections from the RF-reflecting target 224, and detects that the RF-reflecting target 224 has moved a meaningful amount, corresponding to a change in reflected RF signals that exceeds a status change threshold. In an embodiment, the RF-reflecting target 224 is a metal sphere or similar object to reflect RF signals, such as an RF energy retroreflector.

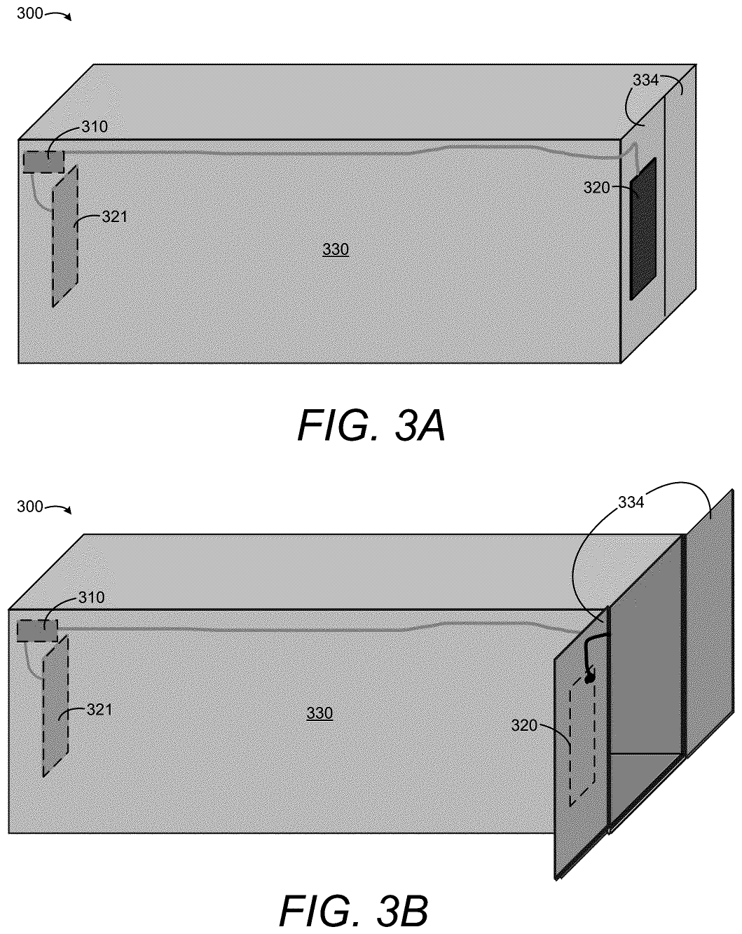

FIG. 3A and FIG. 3B illustrate a system 300 to check a status of a container 330 according to another embodiment. FIG. 3A illustrates the container 330 with doors 334 closed. FIG. 3B illustrates the container 330 with doors 334 open. The system 300 includes controller 310 coupled to antenna1 320 and antenna 321. The antenna1 320 is coupled to an exterior of a door 334 of the container 330. The antenna2 321 is coupled to an interior wall of container 330 furthest from doors 334.

In an embodiment, the interior antenna 321 (shown at a left end of the container 330) monitors for signal changes indicative of EM signals entering the container 330 when the doors 334 are open. An exterior antenna 320 is shown at the right of the container 330, mounted to an outer surface of the left door 334. The interior antenna 321 and exterior antenna 320 are coupled to the controller 310 via cabling. Cabling for the exterior antenna 320 passes through a through-hole of the door 334 of the container 330. In another embodiment, the system 300 monitors the local EM environment for signals, and compares detected signals to the EM signals on the interior across the same frequency range. When the doors 334 are opened, the system 300 detects an appreciable change in the signals for frequencies present in the local environment of the antenna 320, 321. Module placement of antennas 320, 321 in this drawing is shown as an example and should not be restrictive. The small box in the upper rear of the container is representative of the controller 310, which can include a spectrum analyzer (or similar RF equipment), a battery, a communications module, etc. In one embodiment, the controller 310 monitors interior antenna 321 (left end of container 330) for any signal changes indicative of EM signals entering the container 330 when the doors 334 are opened. In another embodiment, the controller 310 monitors the local EM environment for signals using exterior antenna 320, and compares them to the EM signals detected using antenna 321 on the interior across the same frequency range. When the doors 334 are opened, there will be an appreciable change in the detected signals at frequencies present in the local environment. Antenna module placement as depicted in the figures is arbitrary and should not be restrictive.

Embodiments can include the controller 310 in communication with electromagnetic sensors, such as visible light sensors, infrared (IR) sensors, and RF antennas 320, 321. The sensors can be deployed throughout a container 330, or attached to the interior of the container 330. Sensors can be disposed near or on the doors 334 of the container such that, when the doors 334 are opened, the sensors enable the system 300 to detect changes in the radio environment inside or outside the container 330 due to external signals. In another embodiment, the system 300 emits radio signals inside or outside the container 330 and monitors the radio signals inside or outside the container 330 to detect changes that indicate that the container 330 has been opened.

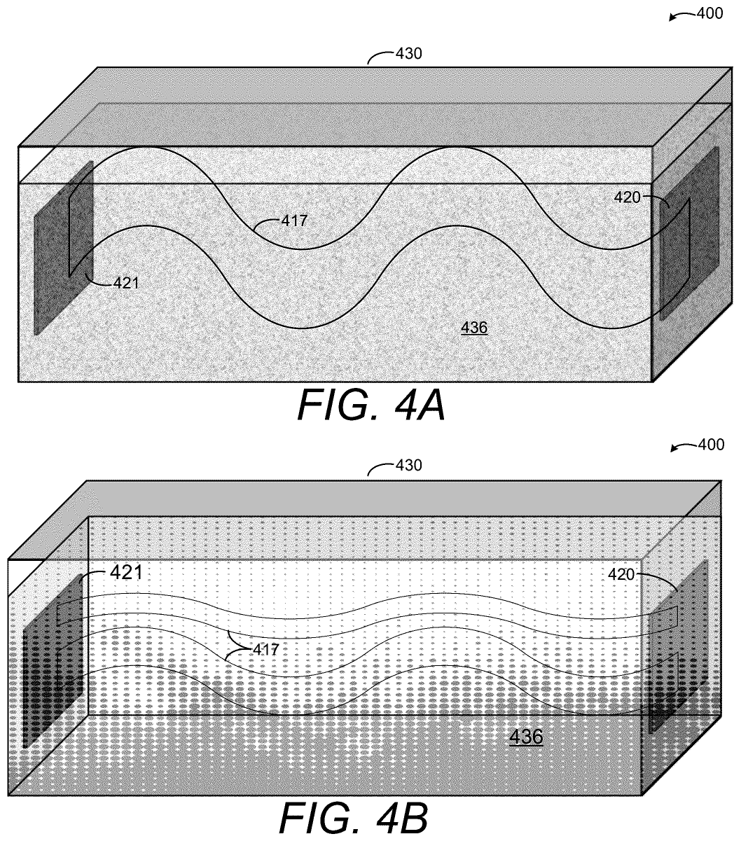

FIG. 4A and FIG. 4B illustrate a system 400 to check a status of a container 430 according to another embodiment. FIG. 4A illustrates the container 430 filled with contents 436 that are homogenously dispersed, e.g., after filling prior to travel. FIG. 4B illustrates the container 430 filled with contents 436 that are inhomogeneously dispersed, e.g., after settling from travel. The system 400 includes antenna1 420 and antenna2 421, to emit and detect generated RF signals 417. The system 400 analyzes differences between the pre-travel generated RF signals 417 and post-travel generated RF signals 417, to determine whether the contents 436 of the container 430 have undergone a change in their distribution of mass. This detection of content distribution is distinct from the content-shifting detection set forth above and as illustrated in FIG. 2. For example, the content distribution can change independent of whether a level of the contents has shifted. It is possible for contents of a full container to undergo a change in distribution while the container remains full. Embodiments can detect shifting of contents 436, whether based on changing levels or changing density distributions, to notify and address risks such shifting poses to cargo crafts by throwing off the distribution and balance of mass in a container.

Embodiments can use the spectrum of resonant modes to characterize the distribution of mass of the contents 436 in the container 430, and monitor for changes in the distribution of mass in the container 430. The application of resonant electromagnetic modes has been proposed to detect the composition and location of objects in a metal enclosure for the purpose of screening bottles for explosives, as described in detail in U.S. Pat. No. 7,378,849. FIG. 4A illustrates a cargo container 430 mostly filled with a granular material that has a random distribution of particles. Transceiver (or transmitter/receiver pair) antennas (black squares labeled as first and second antennas 420, 421) send EM signals 417 through the cargo container 430. FIG. 4B illustrates settling of larger particles of the contents 436 toward the bottom (e.g., after traveling), leading to a detectable change in the EM signals 417 obtained at the receiving antenna(s) 420, 421. The antennas 420, 421 can be flat panel antenna, stub antenna, etc.

In an embodiment, the controller 210 transmits generated RF signals 417 into the container 430 that include a spectrum of resonant modes corresponding to dimensions of the container 430. A controller coupled to the antennas detects an affected spectrum of resonant modes caused by interactions between the generated RF signals 417 and the container 430 and contents 436 of the container 430. The controller characterizes a distribution of mass for the contents 436 of the container 430 based on the affected spectrum of resonant modes.

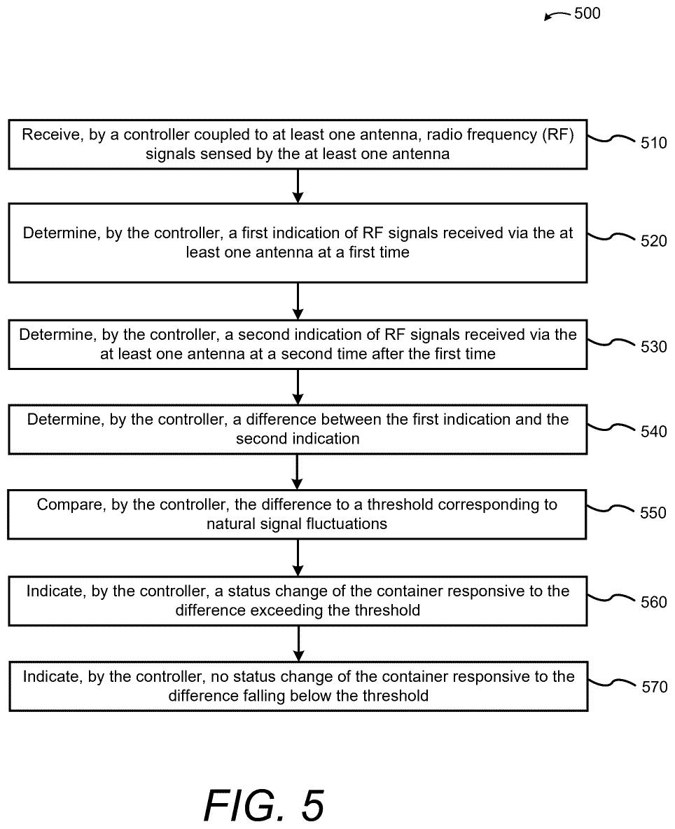

FIG. 5 is a flowchart 500 illustrating a method to check a status of a container according to an embodiment. In block 510, a controller receives RF signals sensed by at least one antenna. For example, the at least one antenna can include one antenna for generating or detecting RF signals, or multiple antennas to perform differential measurements or triangulation. In block 520, the controller determines a first indication of RF signals received via the at least one antenna at a first time. For example, a passive embodiment can sense RF signals present in the environment. An active embodiment can generate RF signals, and detect the generated RF signals. In block 530, the controller determines a second indication of RF signals received via the at least one antenna at a second time after the first time. For example, in one embodiment a controller can sense an initial condition prior to shipping, and an end condition after shipping. Another embodiment can monitor a multitude of conditions over time, and can include storage for storing indications of RF conditions over time. In block 540, the controller determines a difference between the first indication and the second indication. For example, the controller performs a subtraction operation, to subtract an initial average signal strength from a final average signal strength. In block 550, the controller compares the difference to a threshold corresponding to natural signal fluctuations. For example, the controller determines if the difference rises above a threshold level corresponding to natural environmental fluctuations, e.g., 5 dB, 10 dB, 20 dB, user-specified threshold value, or the like as appropriate for environmental conditions that the container is expected to encounter. In block 560, the controller indicates a status change of the container responsive to the difference exceeding the threshold. In one embodiment, the controller is coupled to a display to display the indication that the container has been breached. In another embodiment, the controller is coupled to a communications module that transmits the indication to a remote server for user monitoring. In block 570, the controller indicates no status change of the container responsive to the difference falling below the threshold. For example, the controller generates an indication that the container is intact and has not been breached, and the controller can display, store, transmit, or otherwise maintain such indications of container status.

Blocks 520 or 530 determine first or second indications of RF signals. Embodiments can determine these indications using a passive approach or an active approach, or a combination of active and passive. In a passive embodiment, the controller monitors RF signals naturally available in the environment, and checks for changes in those conditions over time. The controller can use a single antenna inside the container, or multiple antennas inside or outside the container. The controller can apply a differential measurement between the antenna or antennas outside the container vs those inside. In an active embodiment, the controller transmits generated RF signals into the container, which can reflect off container walls and contents of the container to influence the RF indications sensed by the antenna(s). The controller can check for changes in the RF signals such as amplitude or magnitude. The generated RF signals also can reflect in specific patterns that result in reflection nodes. The controller also can check for changes in RF signals related to phase, or other aspects such as whether RF reflection nodes in the container have changed. In an embodiment, the controller takes into account the interior dimensions of the container, e.g., receives user input as to the dimensions of the container, or allows user selection of the specific container type from a menu of selectable container types and uses a lookup table to retrieve the dimensions for that container. The controller also can be pre-configured to generate RF signals that accommodate a specific container type(s). The controller adjusts the generated RF signals to have resonance or resonant modes suited to the container dimensions. The controller transmits generated RF signals into the container that include a spectrum of resonant modes corresponding to dimensions of the container. The controller thereby can detect an affected spectrum of resonant modes caused by interactions with the container and contents of the container, and characterize a distribution of mass for the contents of the container based on the affected spectrum of resonant modes. Thus, the controller can determine not only breaches of the container, but also whether contents of the container have shifted or settled. Embodiments of the controller can also use other techniques for monitoring shifting of contents, such as visible light sensors, infrared (IR) sensors deployed throughout the container and coupled to the controller.

While a number of embodiments of the present subject matter have been described, it should be appreciated that the present subject matter provides many applicable inventive concepts that can be embodied in a wide variety of ways. The embodiments discussed herein are merely illustrative of ways to make and use the subject matter and are not intended to limit the scope of the claimed subject matter. Rather, as will be appreciated by one of skill in the art, the teachings and disclosures herein can be combined or rearranged with other portions of this disclosure and the knowledge of one of ordinary skill in the art.

Terms and phrases used in this document, unless otherwise expressly stated, should be construed as open ended as opposed to closed—e.g., the term “including” should be read as meaning “including, without limitation” or the like; the term “example” is used to provide example instances of the item in discussion, not an exhaustive or limiting list thereof, the terms “a” or should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Furthermore, the presence of broadening words and phrases such as “one or more,” “at least,” “but not limited to,” or other similar phrases, should not be read to mean that the narrower case is intended or required in instances where such broadening phrases may be absent. Any headers used are for convenience and should not be taken as limiting or restricting. Additionally, where this document refers to technologies that would be apparent or known to one of ordinary skill in the art, such technologies encompass those apparent or known to the skilled artisan now or at any time in the future.

What is claimed is:

1. A system to check a status of a container, comprising:
at least one antenna;
a controller coupled to the at least one antenna to receive radio frequency (RF) signals via the at least one antenna, the controller configured to:
determine a first indication of RF signals received via the at least one antenna at a first time;
determine a second indication of RF signals received via the at least one antenna at a second time after the first time;
determine a difference between the first indication and the second indication;
compare the difference to a threshold;
indicate a status change of the container responsive to the difference exceeding the threshold; and
indicate no status change of the container responsive to the difference falling below the threshold.

2. The system of claim 1, wherein the at least one antenna comprises a first antenna disposed inside the container, and a second antenna disposed outside the container, wherein the controller performs differential measurements between RF signals received by the first antenna and the second antenna when determining the first indication and the second indication.

3. The system of claim 1, further comprising an analyzer coupled to the controller to transmit or receive RF signals.

4. The system of claim 1, wherein the controller is further configured to generate generated RF signals, and the at least one antenna comprises a first antenna and a second antenna, wherein the controller injects, using the first antenna, the generated RF signals into the container, and senses, using the second antenna, the generated RF signals injected by the first antenna.

5. The system of claim 1, further comprising a communications module coupled to the controller to communicate with a remote server to exchange instructions and status information regarding the system and the container.

6. The system of claim 1, wherein the threshold is 20 dB to accommodate natural signal fluctuations from changes in an environment of the container when the container travels.

7. The system of claim 1, wherein the controller determines that the difference between the first indication and the second indication, based on detected wavelengths, corresponds to the container being breached by acquiring a hole of a diameter less than that of a door of the container.

8. The system of claim 1, wherein the controller determines that the difference between the first indication and the second indication, based on detected wavelengths, corresponds to opening of a door of the container.

9. The system of claim 1, wherein the controller determines that the difference between the first indication and the second indication, based on detected wavelengths, corresponds to a shifting of contents of the container.

10. The system of claim 1, wherein the controller further comprises a wideband RF energy transceiver and frequency analyzer to generate and analyze the RF signals, the controller being further configured to:
when determining the first indication, transmit generated RF signals into the container via the at least one antenna to cause the generated RF signals to reflect off container walls and contents of the container to influence the first indication at the first time;
when determining the second indication, transmit the generated RF signals into the container via the at least one antenna to cause the RF signals to reflect off container walls and contents of the container to influence the second indication at the second time;
analyze the difference between the first indication and the second indication to determine whether RF reflection nodes in the container have changed; and
indicate the status change of the container responsive to the RF reflection nodes having changed.

11. The system of claim 10, wherein the controller generates a time-varying RF signal when transmitting and analyzing the first indication and the second indication.

12. The system of claim 1, further comprising an RF-reflecting target that is placed on contents of the container, wherein the controller senses reflections from the RF-reflecting target when sensing the first indication and the second indication.

13. The system of claim 12, wherein the RF-reflecting target is a metal sphere.

14. The system of claim 12, wherein the at least one antenna is an array of antennas, and the controller is further configured to identify multiple reflections via the array of antennas and triangulate a location of the RF-reflecting target based on the multiple reflections.

15. The system of claim 1, wherein the controller generates generated RF signals at a resonant frequency corresponding to dimensions of the container.

16. The system of claim 1, wherein the controller is further configured to:
transmit generated RF signals into the container, the generated RF signals including a spectrum of resonant modes corresponding to dimensions of the container;
detect an affected spectrum of resonant modes caused by interactions between the generated RF signals and the container and contents of the container; and
characterize a distribution of mass for the contents of the container based on the affected spectrum of resonant modes.

17. The system of claim 1, wherein the controller further comprises storage, the controller further configured to monitor RF signals over time and store one or more indications of RF signals and status changes.

18. A method for monitoring a container, comprising:
receiving, by a controller coupled to at least one antenna, radio frequency (RF) signals via the at least one antenna;
determining a first indication of RF signals received via the at least one antenna at a first time;
determining, by the controller, a second indication of RF signals received via the at least one antenna at a second time after the first time;
determining, by the controller, a difference between the first indication and the second indication;
comparing, by the controller, the difference to a threshold;
indicating, by the controller, a status change of the container responsive to the difference exceeding the threshold; and
indicating, by the controller, no status change of the container responsive to the difference falling below the threshold.

19. The method of claim 18, further comprising:
transmitting, by the controller when determining the first indication, generated RF signals into the container via the at least one antenna to cause the generated RF signals to reflect off container walls and contents of the container to influence the first indication at the first time;
transmitting, by the controller when determining the second indication, the generated RF signals into the container via the at least one antenna to cause the RF signals to reflect off container walls and contents of the container to influence the second indication at the second time;
analyzing, by the controller, the difference between the first indication and the second indication to determine whether RF reflection nodes in the container have changed; and
indicating, by the controller, the status change of the container responsive to the RF reflection nodes having changed.

20. The method of claim 18, further comprising:
transmitting, by the controller, generated RF signals into the container, the generated RF signals including a spectrum of resonant modes corresponding to dimensions of the container;
detecting, by the controller, an affected spectrum of resonant modes caused by interactions with the container and contents of the container; and
characterizing a distribution of mass for the contents of the container based on the affected spectrum of resonant modes.
